(19) United States
(12) Patent Application Publication
(10) Pub. No.: US 2005/0129352 A1
(43) Pub. Date: Jun. 16, 2005

(54) Optical path control device

(75) Inventors: Shun-ichi Miyazaki, Tokyo (JP); Akira Miura, Tokyo (JP); Shinji Kobayashi, Tokyo (JP); Tadashige Fujita, Tokyo (JP); Chie Sato, Tokyo (JP); Tsuyoshi Yakihara, Tokyo (JP); Sadaharu Oka, Tokyo (JP); Takashi Suzuki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 10/901,184

(22) Filed: Jul. 29, 2004

(30) Foreign Application Priority Data
Dec. 10, 2003 (JP) 2003-411364

(51) Int. Cl. G02B 6/35

(52) U.S. Cl. 385/17

(57) ABSTRACT

An optical path control device includes a hole formed perpendicularly to the plane of a substrate, an optical waveguide formed on the substrate to cover the hole, an upper electrode formed on the optical waveguide above the hole, a lower electrode formed on a bottom part of the hole, and a voltage application unit for applying a voltage between the upper and lower electrodes. As the applied voltage is controlled to change an electrostatic attraction force between the upper and lower electrodes and the magnitude of flexure of the waveguide is thus changed, the traveling direction of light can be changed into an arbitrary direction.

### BACKGROUND OF THE INVENTION

1. Field of the Invention

This invention relates to an optical path control device that can be suitably used in an optical router or the like for future high-speed optical communication, and particularly to an optical path control device that controls the path of light traveling through an optical waveguide.

2. Description of the Related Art

The following are conventional techniques of displacing an optical waveguide with an electrostatic attraction force to change the traveling direction of light.
Patent Reference 1: JP-A-6-160750
Patent Reference 2: JP-A-2000-199870

FIG. 1 is a plan view showing the structure of essential parts of an optical path control device (optical switch) used in an optical router or the like for conventional high-speed optical communication.

In FIG. 1, 20 denotes, for example, a silicon substrate formed in a square shape. On the left side of this substrate, an input port is provided and n incidence units (in FIG. 1, seven incidence units) 21a to 21g are arranged in an array, each of which includes an optical fiber and collimating lens.

On the lower side of this substrate, an output port is provided and n emission units (in FIG. 1, seven emission units) 22a to 22g are arranged in an array, each of which includes an optical fiber and collimating lens similar to those of the incidence unit.

23a to 23g denote micro mirrors standing perpendicularly to the plane of the substrate and inclined by 45 degrees to the traveling direction of light. The micro mirrors 23a to 23g are arranged to reflect light emitted from the incidence units 21a to 21g and to emit the light to the emission units 22a to 22g arranged in the output port.

Meanwhile, in the above-described conventional optical switch, in order to change the traveling direction of light, plural two-dimensional mirrors must be constructed for the plural incidence and emission units (optical fibers with cell photic lenses) prepared on the incidence and emission sides. However, such a structure has the following problems.

1) To construct two-dimensional mirrors, a mirror prepared in a two-dimensional flat shape must be made to stand at a given angle with tweezers or the like, and this process is carried out for plural mirrors. Therefore, the number of preparation steps increases and the reliability of the device is lowered.

2) Since the angle of the mirrors is fixed, light incident from an arbitrary incidence unit cannot be emitted from an arbitrary emission unit.

### SUMMARY OF THE INVENTION

This invention simultaneously solves the foregoing problems. It provides an optical path control device that enables reduction in the number of preparation steps and improvement in the reliability of the device, and also enables light incident from an arbitrary incidence unit to be emitted from an arbitrary emission unit.

### BRIEF DESCRIPTION OF THE DRAWINGS

FIG. 1 is a plan view showing an example of conventional optical path control device.

FIGS. 2A to 2C are explanatory views showing the principle of this invention.

FIGS. 3A and 3B are plan view and partial enlarged sectional view showing an embodiment of an optical path control device according to this invention.

FIGS. 4A to 4F are sectional views showing a process of manufacturing the optical path control device of this invention.

FIG. 5 is a plan view showing another embodiment of this invention.

### DETAILED DESCRIPTION OF THE PREFERRED EMBODIMENTS

Now, an embodiment of an optical path control device according to this invention will be described with reference to the drawings.

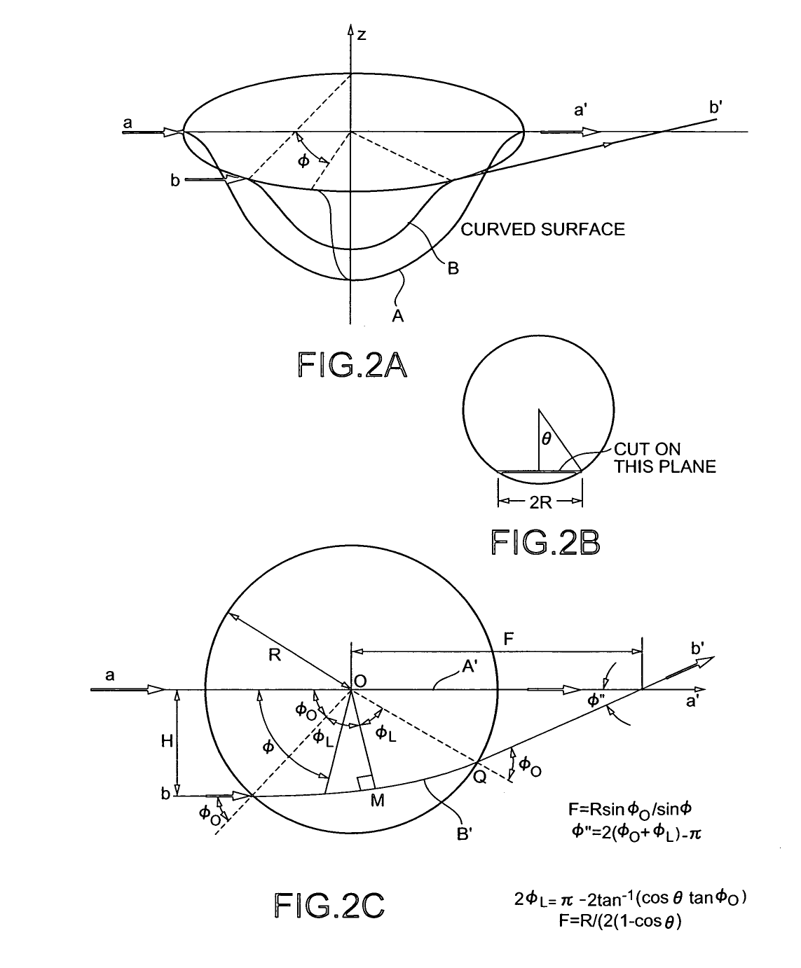

Referring to FIGS. 2A to 2C, the Fermat's theorem to be used in this invention that “a light beam traveling through an optical waveguide follows a geodesic line on a curved surface, that is, a minimum-distance curve connecting two points” will be described first.

FIGS. 2A to 2C show the traveling direction of light incident on a curved lateral surface of a bowl shape. FIG. 2A is a perspective view of the bowl. FIG. 2B shows the position of a cut surface in the case of cutting the bowl from a sphere. FIG. 2C is a plan view of the bowl.

In FIG. 2A, light incident from the direction of an arrow a passes through the part of a curved surface A and is emitted into the direction of an arrow a′. In this case, the light apparently travels straight as shown in the plan view of FIG. 2C.

Next, light incident at the position of an arrow b in FIG. 2A, which is away from the center by a distance H as shown in FIG. 2C, passes through the part of a curved surface B and is emitted into the direction of an arrow b′. In this case, as shown in FIG. 2C, the traveling direction of the light is changed by Φ″ when it is emitted, compared with the case where the light is incident from the direction of the arrow a.

That is, light can be emitted into an arbitrary direction by changing the depth of the bowl or changing the position of the light incident on the bowl.

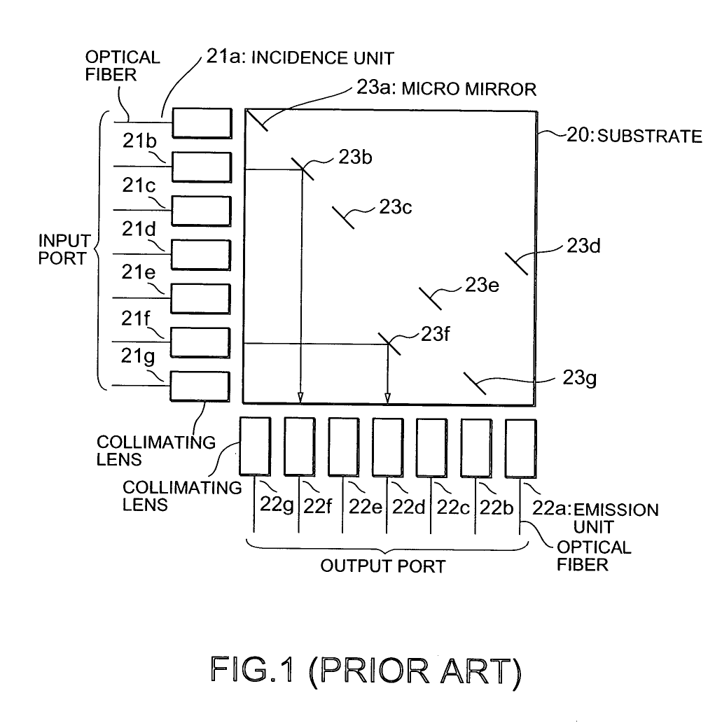

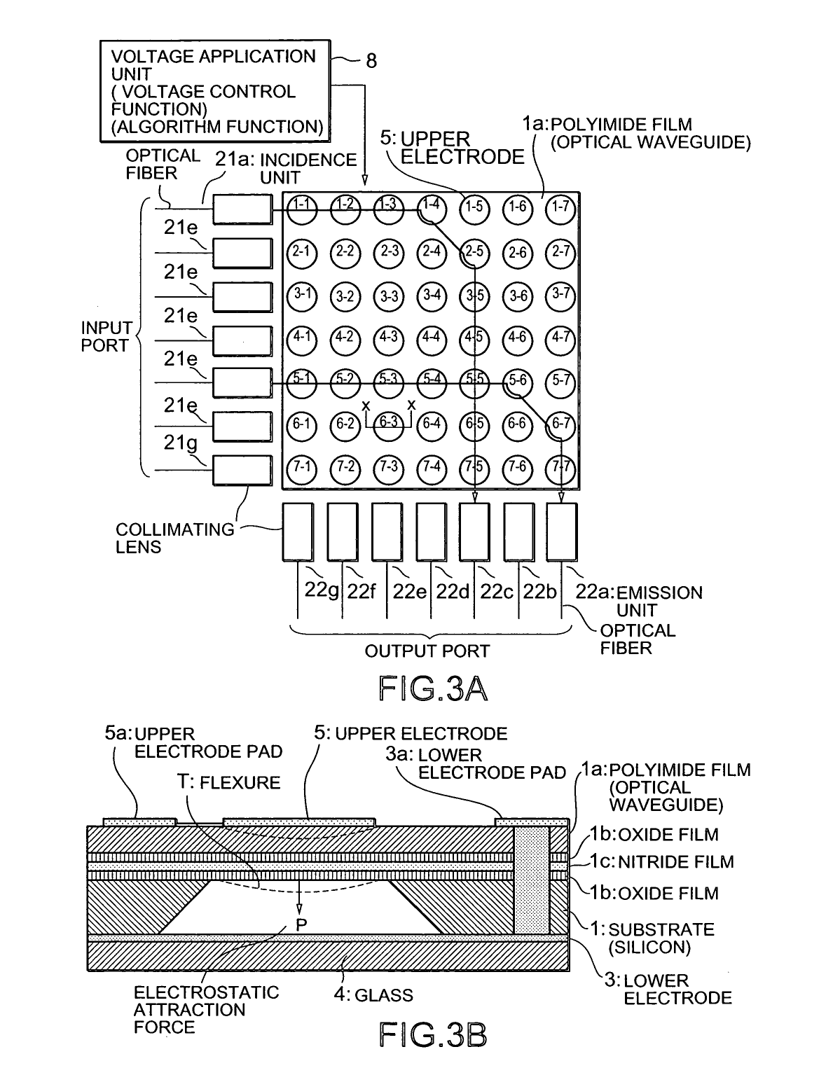

FIG. 3A is a plan view showing essential parts of an embodiment of this invention using the Fermat's theorem shown in FIGS. 2A to 2C. FIG. 3B is a partial enlarged sectional view along a line X-X shown in FIG. 3A. In FIGS. 3A and 3B, the same elements as those of the conventional example shown in FIG. 1 are denoted by the same numerals. In a silicon substrate 1, plural fine spaces 2 of trapezoidal cross section are formed perpendicularly to the plane of the substrate 1. A glass 4 having a lower electrode 3 on its one entire surface is attached to the bottoms of the fine spaces 2 to seal these fine spaces 2.

An oxide film 1b, nitride film 1c, oxide film 1b and polyimide film la are sequentially stacked on the substrate 1. Circular upper electrodes 5 are formed on the polyimide film la above the fine spaces 2. Upper electrode pads 5a are formed near the upper electrodes 5 on the polyimide film 1a. Moreover, lower electrode pads 3a are formed on the polyimide film 1a so as to be connected to the lower electrode 3. On both sides of the polyimide film 1a, a substance having a lower refractive index than the polyimide film 1a is formed (not shown) and functions as an optical waveguide.

A voltage application unit 8 is to apply a voltage between the upper electrode 5 and the lower electrode 3. It has a function of controlling the voltage and an algorithm function.

In the above-described structure, when a voltage is applied between the upper electrode 5 and the lower electrode 3, an electrostatic attraction force P acts between the upper and lower electrodes and flexure T occurs in the optical waveguide 1a. The optical waveguide 1a is thus recessed in a bowl shape.

As a result, on the basis of the above-described Fermat's theorem, the traveling direction of light that travels straight through the optical waveguide 1a within a two-dimensional plane changes. The traveling direction can be controlled by controlling the magnitude of the voltage applied to the electrode 3, the position of incidence of the light beam to be incident on the bowl-shaped recess, or the diameter of the light beam. The measure for controlling the position of incidence of the light beam or the diameter of the light beam is not shown in the drawings.

In FIG. 3A, the plural upper electrodes 5 (in FIG. 3A, 49 upper electrodes) above the fine spaces 2 are formed at cross points on the optical waveguide 1a of the lines extended from incidence units 21a to 21g and emission units 22a to 22g. The centers of the fine spaces 2 (in the example of FIGS. 3A and 3B, circular fine spaces) are properly deviated from the incident light. (The light is deflected into a predetermined direction so as to travel straight through the flatly formed optical waveguide 1a.)

In the above-described structure, light entering an incidence unit 21 at an arbitrary position travels straight through the optical waveguide within the two-dimensional plane. However, when a voltage is applied between the upper electrode 5 existing at the cross point and the lower electrode 3 via the electrode pads 5a and 3a, an electrostatic attraction force P occurs between the electrodes. As a result, flexure T (bowl-shaped recess) occurs in the vertical direction of the optical waveguide 1a and the traveling direction of the light within the two-dimensional plane changes.

The traveling direction of the light is controlled by controlling the magnitude of the applied voltage, the position of incidence of the light beam to be incident, or the diameter of the light beam. Although FIG. 3B shows that the traveling direction of the light changes at the center of the upper electrode 5, the light actually travels along the curved surface of the fine hole and thus changes on the basis of the above-described Fermat's theorem.

Therefore, as the plural fine holes are arranged in a matrix form with respect to the plural incidence and emission units and a voltage is applied to an electrode at an arbitrary position from the voltage application unit 8 using a proper algorithm to optimally control the electrostatic attraction force, the light from the incidence unit 21 can be guided to an arbitrary emission unit 22 at a high speed and without any loss.

FIG. 3A shows a state where a voltage is applied only between the voltages 1-4, 2-5, 5-6 and 6-7 of the upper electrodes 5 and the lower electrode 3 and bowl-shaped flexure occurs in these parts.

In such a state, a light beam incident from the incidence unit 21a has its traveling direction changed at the electrodes 1-4 and 2-5 and becomes incident on the emission unit 22c arranged in the output port. A light beam incident from the incidence unit 21e has its traveling direction changed at the electrode 5-6 and 6-7 and becomes incident on the emission unit 22a arranged in the output port.

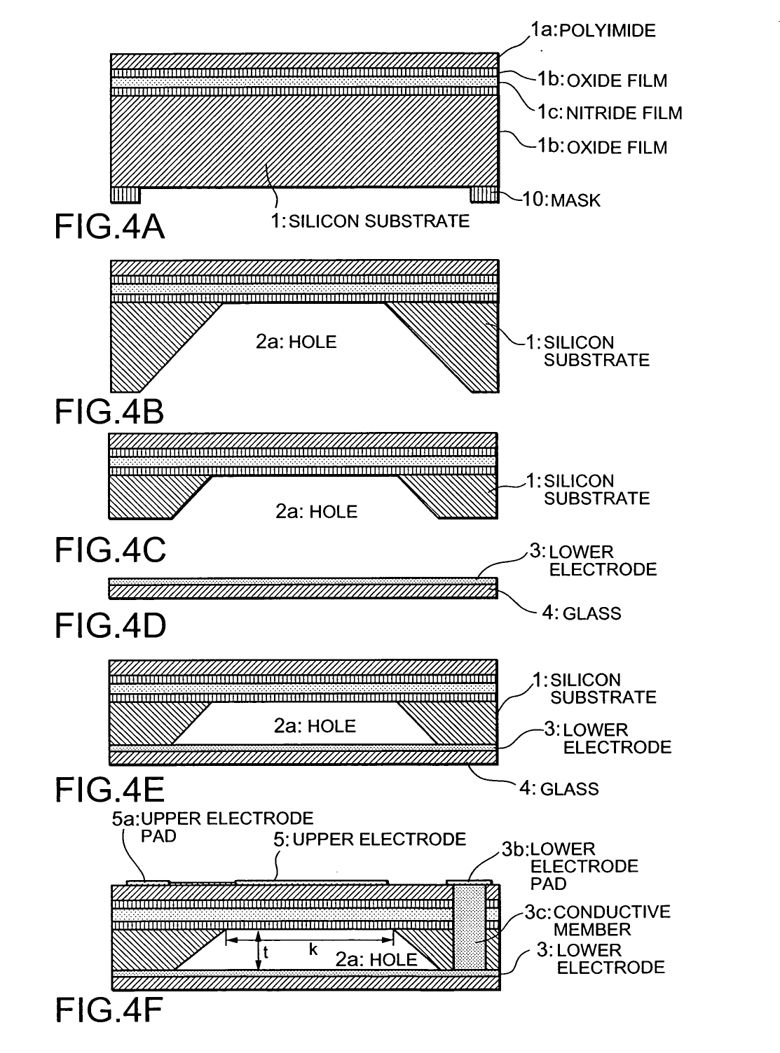

FIGS. 4A to 4F are sectional views showing essential parts of a process of manufacturing the optical path control device shown in FIGS. 3A and 3B. The process steps will be described sequentially.

At step a, the oxide film 1b, nitride film 1c, oxide film 1b and polyimide film 1a are sequentially stacked on one side of the silicon substrate 1. On both sides of the polyimide film 1a, a substance having a lower refractive index than the polyimide film 1a is formed (not shown) as an optical waveguide. Also an oxide film is formed on the other side and a part of this oxide film is removed to form a mask 10.

At step b, a hole 2a is formed on the side where the mask 10 is formed, using an etching solution such as hydrazine.

At step c, mechanical polishing or equivalent processing is performed on the side where the hole 2a is formed, thus adjusting the depth of the hole 2a.

At step d, the glass 4 having the lower electrode 3 formed on its one side is prepared.

At step e, the side of the lower electrode 3 of the glass 4 prepared at step d is joined to the side of the substrate 1 where the hole 2a is formed, using anode junction or the like.

At step f, the upper electrode 5 is formed above the hole 2a, and the upper electrode pad 5a is formed near the hole 2a and connected to the upper electrode 5.

Next, a hole is formed which reaches the lower electrode 3 from the side where the polyimide film 1a is formed, and a conductive member 3c is embedded therein. A lower electrode pad 3b connected to the conductive member 3c is formed on the polyimide film 1a.

The thickness t of the fine space (hole) 2a is several μm, and the diameter k of the space is approximately several hundred μm.

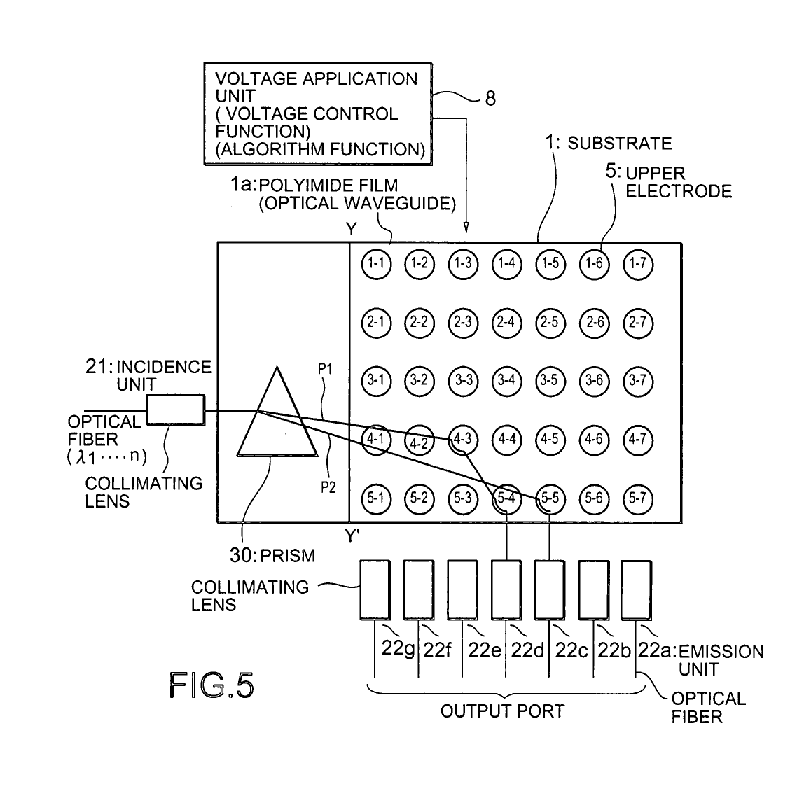

FIG. 5 is a plan view showing essential parts of another embodiment. Specifically, an optical waveguide, fine holes, and upper and lower electrodes that are similar to those shown in FIG. 3 are formed on the right side of a line Y-Y′ on a substrate 1. On the left side of the line Y-Y′, a step is formed so that light can be incident from an end part of an optical waveguide 1a.

Also in this embodiment, a voltage application unit 8 is provided, which is driven by a voltage control function and algorithm for applying a voltage to the upper and lower electrodes.

In this embodiment, one incidence unit 21 is arranged on the input port side and a prism 30 is arranged on the subsequent stage. Light having different wavelengths λ1 to λn becomes incident on the incidence unit 21. (In FIG. 5, light having two types of wavelengths are branched into two directions.)

In the above-described structure, light emitted from the incidence unit 21 becomes incident on the prism 30 and is divided by wavelength because of the wavelength dispersion effect of the prism. The light emitted from the prism 30 becomes incident on the optical waveguide 1a formed on the substrate 1 and travels straight. The traveling direction of this light is changed by a bowl-shaped recess formed by a fine hole (not shown) and the optical waveguide.

That is, a voltage applied to an arbitrary electrode of plural upper electrodes 5 and a lower electrode 3 (see FIG. 3B) that are arranged to face each other via fine holes is controlled to change the electrostatic attraction force, and the depth of the bowl-shaped recess formed by the optical waveguide is thus changed to change the traveling direction through the optical waveguide. The light of the divided wavelengths can be emitted from an arbitrary emission unit 22.

In FIG. 5, light having a wavelength P1 has its traveling direction changed at electrodes 4-3 and 5-4 and becomes incident on the emission unit 22d, and light having a wavelength P2 has its traveling direction changed at an electrode 5-5 and becomes incident on the emission unit 22c.

In the above description of this invention, the specific preferred embodiments are described for the purpose of explanation and illustration. Therefore, it is obvious to those skilled in the art that various changes and modifications can be made without departing from the scope of this invention. For example, while the upper electrodes 5 are circular in the above-described embodiments, they may be triangular or elliptic. Moreover, while 7×5 upper electrodes 5 are provided in the above-described embodiments, the number of upper electrodes is not limited to this and formation of more upper electrodes enables smooth control of the traveling direction of light.

The scope of this invention defined by the description of claims includes changes and modifications within the scope.

This invention has the following effects.

An optical path control device includes a hole formed perpendicularly to the plane of a substrate, an optical waveguide formed on the substrate to cover the hole, an upper electrode formed on the optical waveguide above the hole, a lower electrode formed on a bottom part of the hole, and a voltage application unit for applying a voltage between the upper and lower electrodes. As the applied voltage is controlled to change an electrostatic attraction force between the upper and lower electrodes and the magnitude of flexure of the waveguide is thus changed, the traveling direction of light can be changed into an arbitrary direction.

Another optical path control device includes plural holes formed perpendicularly to the plane of a substrate, an optical waveguide formed on the substrate to cover the holes, upper electrodes formed on the optical waveguide above the plural holes, respectively, a lower electrode formed on bottom parts of the plural holes, and a voltage application unit for applying a voltage between the plural upper electrodes and the lower electrode.

The plural holes formed in the substrate are arranged in a matrix form. Plural incidence units are provided at one end of the substrate and plural emission units are provided at the other end. The upper electrodes are formed on the optical waveguide above the plural holes, respectively, and a voltage is applied to an arbitrary electrode of the plural upper electrodes by the voltage application unit. As the voltage is controlled to change an electrostatic attraction force between the upper and lower electrodes and the magnitude of flexure of the optical waveguide is thus changed, an optical path control device having a high degree of freedom in control and having small size and high reliability can be realized.

Another optical path control device includes plural holes formed perpendicularly to the plane of a substrate, an optical waveguide formed on the substrate to cover the holes, upper electrodes formed on the optical waveguide above the plural holes, respectively, a lower electrodes formed on bottom parts of the plural holes, at least one incidence unit on which multiple light becomes incident, a micro prism arranged on a stage subsequent to the incidence unit, plural emission units arranged at an end of the substrate, and a voltage application unit for applying a voltage between the plural upper electrodes and the lower electrode. As the voltage applied to the plural electrodes is controlled to change an electrostatic attraction force between the upper and lower electrodes and the magnitude of flexure of the optical waveguide is thus changed, light of a limited wavelength range can be outputted from an arbitrary output port.

Moreover, as an incident light position or light beam spot diameter control unit for controlling the position of incident light incident on the optical waveguide or spot diameter of a light beam is provided, an optical path control device having a high degree of freedom in control can be realized.

As an algorithm function for realizing optimum control is used to selectively emit light incident on an arbitrary incidence unit to an arbitrary emission unit, responsiveness and degree of freedom can be improved, and an optical path control device that is highly flexible to cope with changes in communication quantity and communication troubles can be realized.

Moreover, as a silicon substrate with a polysilicon, SiO₂ and SiN films deposited thereon is used as the substrate and a polyimide film is used as the optical waveguide, a small-sized and highly reliable optical switch can be realized.

1. An optical path control device comprising a hole formed perpendicularly to the plane of a substrate, an optical waveguide formed on the substrate to cover the hole, an upper electrode formed on the optical waveguide above the hole, a lower electrode formed on a bottom part of the hole, and a voltage application unit for applying a voltage between the upper and lower electrodes.

2. The optical path control device as claimed in claim 1, wherein the optical waveguide is formed to flex toward the hole because of an electrostatic attraction force generated by the voltage applied between the upper and lower electrodes.

3. The optical path control device as claimed in claim 1 or 2, wherein the voltage applied between the upper and lower electrodes is controlled to change the electrostatic attraction force and the magnitude of flexure of the waveguide is thus changed.

4. An optical path control device comprising plural holes formed perpendicularly to the plane of a substrate, an optical waveguide formed on the substrate to cover the holes, upper electrodes formed on the optical waveguide above the plural holes, respectively, a lower electrode formed on bottom parts of the plural holes, and a voltage application unit for applying a voltage between the plural upper electrodes and the lower electrode.

5. The optical path control device as claimed in claim 4, wherein the plural holes formed in the substrate are arranged in a matrix form, plural incidence units are provided at one end of the substrate, and plural emission units are provided at the other end.

6. The optical path control device as claimed in claim 4 or 5, wherein the upper electrodes are formed on the optical waveguide above the plural holes, respectively, and a voltage applied to an arbitrary electrode of the plural upper electrodes by the voltage application unit is controlled to change an electrostatic attraction force between the upper and lower electrodes and the magnitude of flexure of the optical waveguide is thus changed.

7. An optical path control device comprising plural holes formed perpendicularly to the plane of a substrate, an optical waveguide formed on the substrate to cover the holes, upper electrodes formed on the optical waveguide above the plural holes, respectively, a lower electrodes formed on bottom parts of the plural holes, at least one incidence unit on which multiple light becomes incident, a micro prism arranged on a stage subsequent to the incidence unit, plural emission units arranged at an end of the substrate, and a voltage application unit for applying a voltage between the plural upper electrodes and the lower electrode, wherein a voltage applied to an arbitrary electrode of the plural upper electrodes is controlled to change an electrostatic attraction force between the upper and lower electrodes and the magnitude of flexure of the optical waveguide is thus changed.

8. The optical path control device as claimed in claim 1 or 4 or 7, further comprising an incident light position or light beam spot diameter control unit for controlling the position of incident light incident on the optical waveguide or spot diameter of a light beam.

9. The optical path control device as claimed in claim 4 or 7, wherein an algorithm function for realizing optimum control of the voltage applied between the upper and lower electrodes is used to selectively emit light incident on an arbitrary incidence unit to an arbitrary emission unit.

10. The optical path control device as claimed in claim 1 or 4 or 7, wherein a silicon substrate with a polysilicon, SiO₂ and SiN films deposited thereon is used as the substrate, and a polyimide film is used as the optical waveguide.
